(19) United States
(12) Patent Application Publication
(10) Pub. No.: US 2011/0113897 A1
(43) Pub. Date: May 19, 2011

(54) SHACKLE-BAR WITH LOAD-CELL

(75) Inventor: Gerald Sidney SIMONS, (US)

(73) Assignee: Weigh Point Incorporated, Cambridge (CA)

(21) Appl. No.: 12/944,789

(22) Filed: Nov. 12, 2010

Related U.S. Application Data
(60) Provisional application No. 61/281,111, filed on Nov. 13, 2009.

(51) Int. Cl. B66C 13/16

(52) U.S. Cl. 73/862.56

(57) ABSTRACT

For use with cranes or hoists, the traditional shackle-bolt through-hole in the shackle-bar is elongated into a slot. A sub-unit comprising a cell-block, a load-cell, a load-block, and one of the shackle-bolts, is placed in the slot. The load-cell, of suitable size, is housed in a very robust manner, and yet the load capacity of the shackle-bar is unaffected by being so modified.

This technology relates to shackle-bars, of the kind used in cranes and hoists as a load-carrying element that bridges between the load-lifting cable or chain above, and the load below.

The present technology includes arranging a load-cell in the shackle-bar in such manner as to make possible an accurate measurement of the magnitude of the load carried by the shackle-bar.

### DETAILED DESCRIPTION OF PREFERRED EMBODIMENTS

The technology will now be further described with reference to the accompanying drawings, in which:

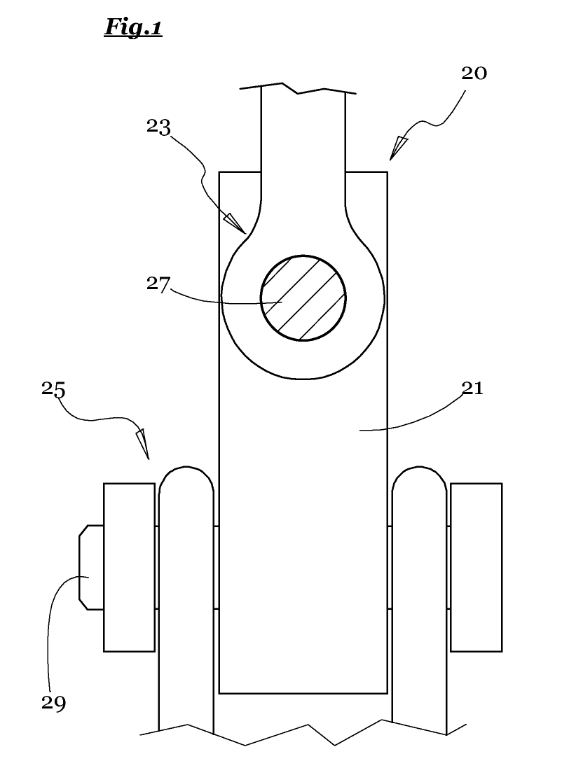

FIG. 1 is a shackle-bar assembly which has been arranged conventionally. There is no provision, in FIG. 1, for measuring the load supported by the shackle-bar.

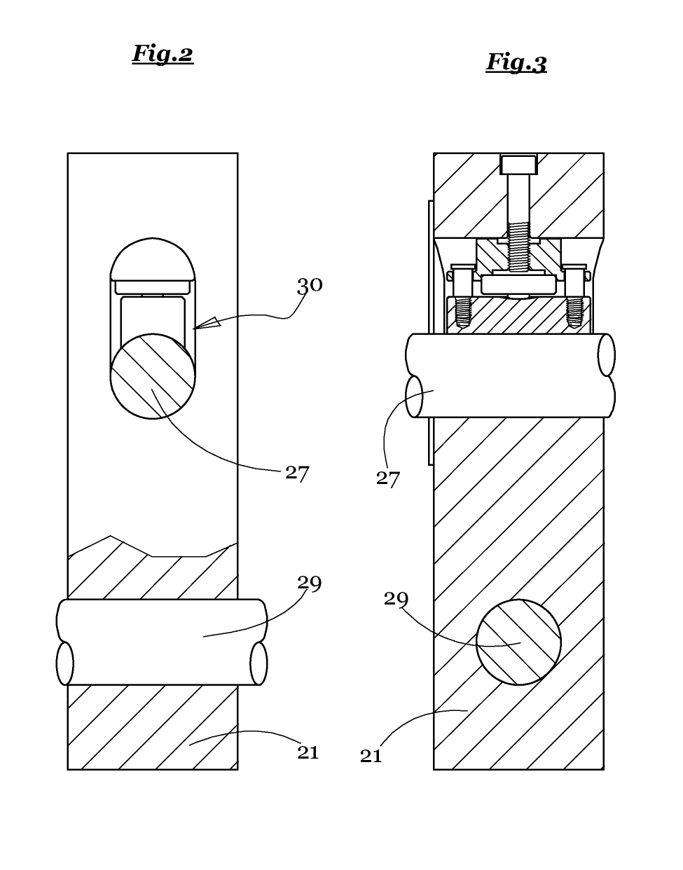

FIG. 2 is a side elevation of a shackle-bar assembly that includes a load-cell load-measuring system according to the technology described in this specification.

FIG. 2A repeats FIG. 2 at a larger scale, but shows less of the assembly.

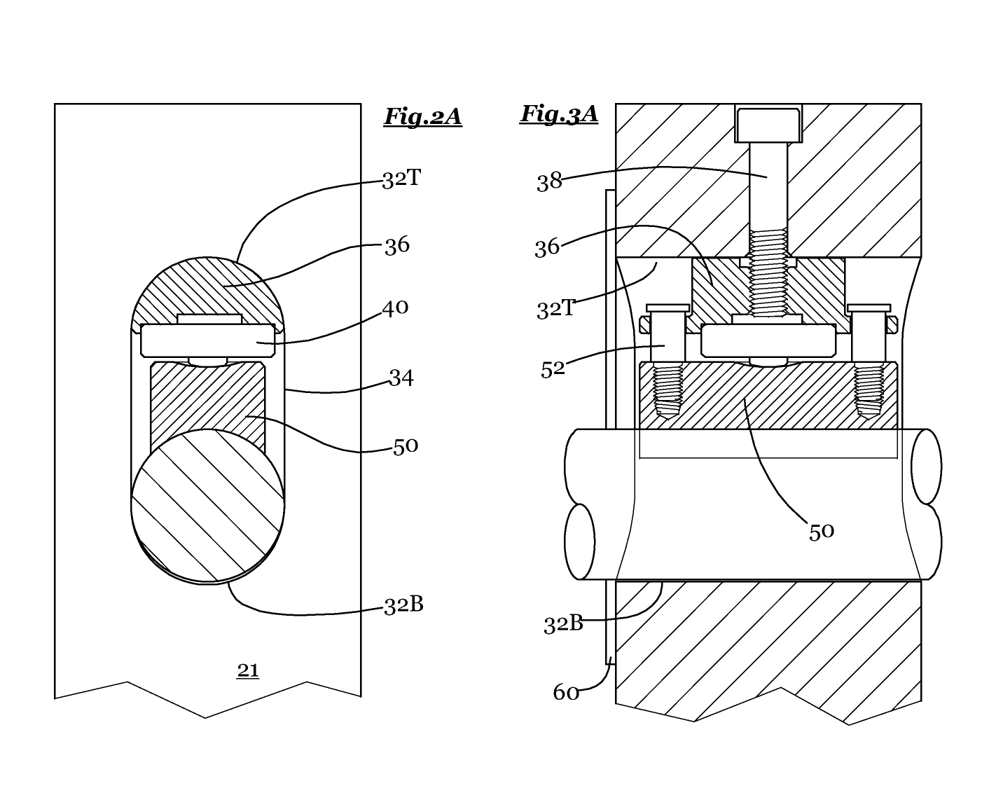

FIG. 3 is a front elevation of the shackle-bar assembly of FIG. 2

FIG. 3A repeats FIG. 3 at a larger scale, but shows less of the assembly.

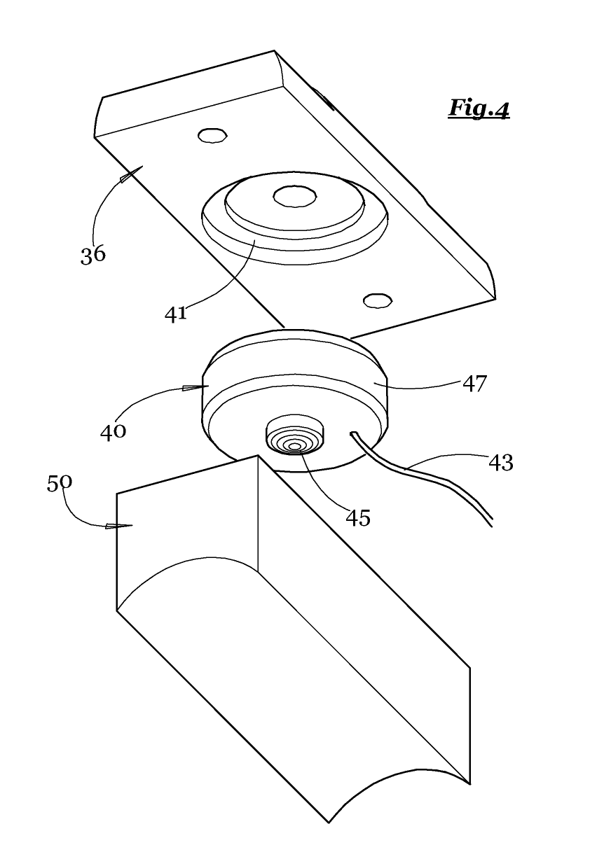

FIG. 4 is an exploded pictorial view, from underneath, of some of the components of the assembly of FIG. 2

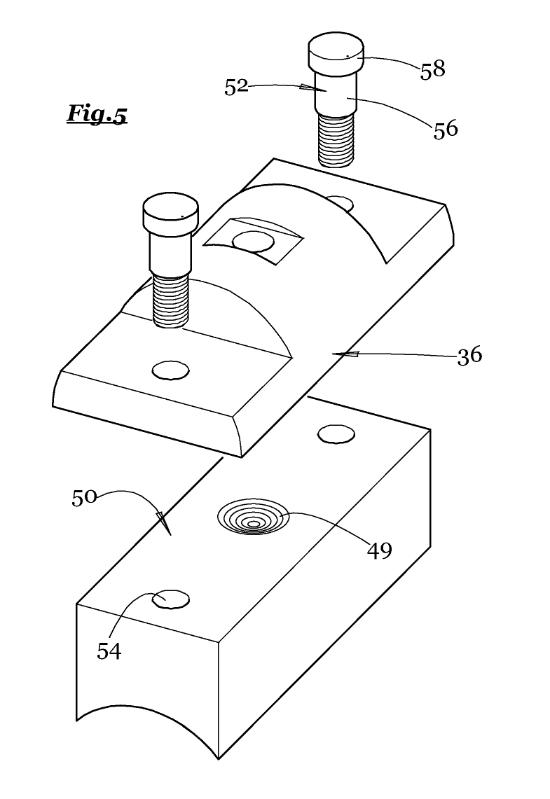

FIG. 5 corresponds to FIG. 4, but shows the components from above. The load-cell is omitted in FIG. 5.

FIG. 1 shows a shackle-bar assembly 20 to which a load-cell load-measuring system according to the technology described in this specification can be incorporated.

In FIG. 1, a shackle-bar 21 connects two bolt-type shackles 23,25. The shackle-bar assembly 20 is of the kind that is used in cranes and hoists as a load-carrying element that bridges between the load-lifting cable or chain above, and the load below.

The present load-measuring technology can be applied to a wide range of sizes and capacities. In the depicted example, the shackle-bar assembly 20 has a safe working load of forty tonnes, and the upper and lower shackle-bolts 27,29 have a diameter of fifty millimetres (five cm).

The shackle-bar 21, as shown, is round (i.e right-cylindrical). In an alternative, the shackle-bar is rectangular, especially square. (In fact, the drawings can be regarded as also depicting a shackle-bar of square cross-section.)

As shown in FIGS. 2,2A,3,3A,4,5, the load-cell and associated components are housed in a slot 30 that is machined in the shackle-bar 21. The slot 30 runs across from side to side of the shackle-bar 21, and has the same cross-sectional configuration at all points along its length.

The slot 30 is running-track-shaped as to its cross-sectional profile. That is to say, the slot comprises top and bottom semi-circular walls 32T,32B, connected by left and right straight side-walls 34.

A cell-block 36 resides in contact with the top semi-circular wall 32T of the slot 30. The cell-block 36 is held tightly against the wall 32T by means of a fastener 38. The top surface 38 of the cell-block 36 is of a semi-circular profile, corresponding to the top wall 32T.

A body of the load-cell 40 is let into a body-recess 41 in the underside of the cell-block 36. The load-cell is a tight press-fit in the recess 41, preferably to the extent that the load-cell is rigidly integrated into the cell-block, once installed.

Electrical wires 43 from the load-cell 40 lead to a (not shown, conventional) power supply, bridge circuit, display meter, calibrator, etc.

The load-cell 40 is formed with a domed button-actuator 45, which protrudes from the body 47 of the load-cell, and protrudes downwards below the cell-block 36.

The domed button-actuator 45 fits into a concavely-dished button-recess 49 in a load-block 50. The radius in the dished recess 49 is slightly greater than the radius of the domed button 45.

The load-block 50 lies on top of the upper shackle-bolt 27, and is shaped to engage the cylindrical surface of the shackle-bolt 27. The shackle-bolt 27, in turn, engages the bottom semi-circular wall 32B of the running-track-shaped slot 30 in the shackle-bar 20.

When the shackle-bar assembly 20 is transmitting a load, the ends of the upper shackle-bolt 27 are attached to the crane, and the upper shackle-bolt 27 presses upwards against the load-block 50. The upper shackle-bolt 27 thus, under load, moves out of contact with the bottom semi-circular end-wall 32B of the slot 30.

The load-block 50 in turn presses upwards against the domed button-actuator 45 of the load-cell 40. The load-cell 40 in turn presses upwards against the cell-block 36, and the cell-block 36 in turn presses upwards against the top semi-circular wall 32T of the slot 30 in the shackle-bar 21.

The shackle-bar assembly 20 transmits the load from the lower shackle-bolt 29 to the upper shackle-bolt 27, and the arrangement of the assembly 20 is such that the load passes through the load-cell 40, and none of the load is transmitted through the shackle-bar assembly other than through the load-cell 40. Thus, the load is transmitted in such manner as not to detract from the accuracy of the measurement of the load.

The load-cell 40 is conventional, in itself. It includes an elastically deflectable member, the deflection of which is measured by strain gauges, the electrical output of which is transduced to indicate the magnitude of the load—which can be read on a suitable meter. In this case, the load-cell is circular, and the elastically deflectable member inside is an annular disk. Applying the load produces a conical deflection of the disk, and strain gauges on the disk measure that deflection.

It is recognized that a circular or annular load-cell is very readily accommodated within the shackle-bar-slot 30. That is to say, a circular load-cell of a forty-tonne capacity, available as a proprietary product, fits conveniently into a five-cm wide slot.

Thus, the slot need not be wider than the shackle-bolt. This is advantageous: the width W-slot of the slot 30 has to be slightly wider than the shackle-bolt 27, of course, in order for the bolt to be received within the slot; if the slot had to be substantially wider than the bolt—in order to receive a larger load-cell for instance—that might weaken the shackle-bar itself, i.e might affect the load capacity of the bar.

Other load-cell configurations can, however, be used. For example, a bar-type load-cell, the deflection of which is measured with strain-gauges, can be used to signal the magnitude of the force or load acting through the shackle-bar assembly.

The load-cell 40 should be regarded as fragile. It should be protected against the violently abusive knocks and blows to which shackle bars are inevitably subjected. In particular, the load-cell should not protrude outside the envelope of the shackle-bar 21 itself. The designer should see to it that a robust cover 60 is placed around the shackle-bar, to cover the open ends of the slot 20, and thus to protect the load-cell and the associated components inside. It is recognized that it is very easy to do that. A simple cover, so placed, renders the assembly robust enough that the crane operators do not have to be warned to take special precautions to protect the load-cell.

The load-block 50 is loosely attached to the cell-block 36. Two pillar-bolts 52 are screwed tightly into threaded holes 54 formed in the upper surface of the load-block. The pillars 56 of the pillar-bolts 52 are a loose clearance fit in holes 54 in the cell-block 36, to the extent that the load-block 50 can move freely, in the up/down direction, with respect to the cell-block 36. The pillars constrain the load-block against every other mode of movement relative to the cell-block.

The range of permitted movement is limited by heads 56 on the pillar-bolts 50. The range of permitted up/down movement of the load-block 50 is large enough that, when there is no load on the assembly 20, the domed button-actuator 45 can break contact with the dished recess 49 in the load-block 50. Thus, when there is no load on the assembly 20, the load-block 50 makes no forceful contact with either the button 45 or the lower shackle-bolt 29.

The shackle-bolt 27, the load-block 50, the load-cell 40, and the cell-block 36 together form a stack of components that fit inside the slot. The vertical height H-slot of the slot is slightly larger than the vertical height H-stack of the stack of components.

It is not essential that the cell-block 36 be firmly fixed and rigidly integrated into the shackle-bar 21. However, bolting the cell-block to the shackle-bar does ensure that the cell-block is always in the correct orientation and location. The presence of the bolt 38, and of the hole through which the bolt passes, located on the centreline of the shackle-bar 21, has no effect on the strength of the shackle-bar.

It is preferred that the cell-block and the load-block should be loosely bolted together in the manner shown, this arrangement being advantageous both during normal operation and during assembly of the stack of components into the slot.

When there is no load on the assembly 20, the load-block 50 is constrained as to its position only by the (loose) fit of the pillars 56 in the holes 60 in the cell-block 36. One function of the pillar-bolts 52 is to prevent the load-block from falling, or being knocked, out of position when the shackle-bar assembly 20 is not carrying any load, during normal operation of the assembly. At this time, the heads 58 on the pillar-bolts are not needed, because the height H-stack of the stack of components is only slightly smaller than the height H-slot of the slot. The heads 58 of the pillar-bolts are provided in order to keep the stack together, as a sub-unit, prior to and during assembly of the stack of components into the slot.

On the other hand, when the shackle-bar assembly is supporting a load, the pillar-bolts preferably nominally should not touch the cell-block 36; any contact now between the cell-block and the pillar-bolts, if such were to occur with any degree of forcefulness, would or might affect the accuracy with which the load-cell measures the magnitude of the load.

The designer should see to it that there is enough clearance to enable the components, during assembly, and when not under load, to be loose, and in particular to enable the button of the load-cell to be relieved of all force when the assembly is not under load. The stack of components should fit loosely in the slot, both as to width and as to height.

As mentioned, the shackle-bar 21 has been modified by the presence of the fastener 38, but this does not weaken the shackle-bar. The shackle-bar is of course also modified by the presence of the slot 30, instead of a simple through-hole, and this modification, too, does not weaken the shackle-bar.

The shackle-bar 21 is already designed to cater for the presence of the through-holes which receive the shackle-bolts 27,29; it follows that elongating one of those holes, in order to form the slot 30, also has no effect to weaken the shackle-bar. The shackle-bar, having been designed to be strong enough despite the through-hole, is equally strong enough despite the slot, to support the imposed vertically-induced tensile stresses. As mentioned, however, the slot should not be wider than the through-hole, i.e the slot should not be more than the slight amount wider than the shackle-bolt needed to enable the bolt to be assembled into the slot.

Preferably, the shackle-bolt is of right-cylindrical form, having a head at one end and a screw-thread at the other. However, the shackle-bolt can be of another form: for example, an alternative shackle-bar can be a rectangular or square rod.

In the drawings, the slot and the associated stack of components are shown in respect of the upper shackle. It will be understood that the assembly as disclosed in FIGS. 2-5 may simply be turned upside down, and use in such orientation is included. Of course, whatever the orientation, the assembly must be so arranged that the load whose magnitude is being measured does pass through the load-cell.

In this specification, the expression “shackle-bar” should not be narrowly construed. The shackle-bar is a structure that is robust enough to sustain the supported load; indeed, in many jurisdictions, for use in hoists and cranes, the load capacity of components such as shackle-bars must be officially certified. Although the shackle-bar includes the shackle-bar-slot, as described, it is not essential that the shackle-bar must have an additional through-hole, for receiving a second shackle-bolt. The size and shape of the shackle-bar should be such as to support the load, and to perform the functions required of it, but apart from that the shackle-bar is not limited as to size and shape. For convenience, the shackle-bar, when under load, should be stressed in tension.

The numerals used in the drawings are summarized as follows.
20 shackle-bar assembly
21 shackle-bar
23 upper bolt-type shackle
25 lower bolt-type shackle
27 upper shackle-bolt
29 lower shackle-bolt
30 slot in the shackle-bar
32T, 32B top and bottom semi-circular end-walls of the slot 30
34 left and right straight side-walls of the slot 30
36 cell-block
38 fastener
40 load-cell
41 recess for the load-cell 40, in the cell-block 36
43 electrical wires of the load-cell 40
45 domed button-actuator of the load-cell 40
47 body of the load-cell 40
49 dished recess in the load-block 50
50 load-block
52 pillar-bolts
54 threaded holes in the load-block 50
56 pillars of the pillar-bolts 52
58 heads on the pillar-bolts 52
60 cover, overlies the open ends of slot 30

Terms of orientation (e.g “up/down”, “left/right”, and the like) when used herein are intended to be construed as follows. The terms being applied to a device, that device is distinguished by the terms of orientation only if there is not one single orientation into which the device, or an image (including a mirror image) of the device, could be placed, in which the terms could be applied consistently.

Terms used herein, such as “cylindrical”, “vertical”, and the like, which define respective theoretical constructs, are intended to be construed according to the purposive construction.

A reference to a component being “integrated rigidly” into another component means, herein, that the two components are either formed from one common piece of material, or, if formed separately, are fixed together so firmly and rigidly as to be functionally and operationally equivalent to having been formed from one common piece of material.

The scope of the patent protection sought herein is defined by the accompanying claims. The apparatuses and procedures shown in the accompanying drawings and described herein are examples.

1. A shackle-bar assembly, including:
a shackle-bar, formed with a shackle-bar-slot;
a slot-stack of components, including:
a shackle-bolt; a load-cell; a cell-block; and a load-block; wherein:
the shackle-bar-assembly is structured and arranged to transmit a load carried by the shackle-bar to the shackle-bolt;
the load-cell is structured and arranged to emit a signal indicative of such load as is transmitted through the load-cell;
the slot has top and bottom end-walls and left and right side-walls;
the components of the slot-stack are structured and arranged to transmit the load compressively (a) between the shackle-bolt and the load-block, (b) between the load-block and the load-cell, (c) between the load-cell and the cell-block, and (d) between the cell-block and the top end-wall of the shackle-bar-slot;
the slot-stack has a height H-stack and a width W-stack;
the slot has a height H-slot between the end-walls and a width W-slot between the side-walls;
W-slot is of such width as to receive one of the shackle-bolts; and
H-stack is slightly smaller than H-slot, and W-stack is slightly smaller than W-slot.

2. As in claim 1, wherein:
the components of the slot-stack are arranged in the shackle-bar-slot in the following order, vertically:
the shackle-bolt, which is in contact with or near the bottom end-wall;
above that, the load-block, which is in contact with or near the shackle-bolt;
above that, the load-cell, which is in contact with or near the load-block;
above that, the cell-block, which is in contact with or near the load-cell; and
the cell-block is in contact with or near the top-wall of the shackle-bar-slot.

3. As in claim 2, wherein the load-block is formed, as to an undersurface thereof, with a profile corresponding to the shackle-bolt.

4. As in claim 1, wherein:
the load-cell includes a body and a deflectable button;
one of either the cell-block or the load-block includes a body-recess, in which is received the body of the load-cell; and
the other of the cell-block and the load-block includes a button-recess, in which is received the button of the load-cell.

5. As in claim 4, wherein, when the assembly is not under load, the load-cell button makes no forceful contact with the button-recess.

6. As in claim 5, wherein:
the cell-block is formed, as to an upper surface thereof, with a profile corresponding to the upper top end-wall of the shackle-bar-slot;
the cell-block is rigidly integrated into the top end-wall of the slot; and
the cell-block includes the body-recess, and the body of the load-cell is rigidly integrated thereinto.

7. As in claim 1, wherein:
the assembly includes an up/down movement guide; and
the guide is effective to constrain the load-block against all modes of movement relative to the cell-block, other than up/down relative movement.

8. As in claim 7, wherein the guide includes a pillar that is rigidly integrated into one of either the cell-block or the load-block, and is slidable in the up/down direction relative to the other.

9. As in claim 1, wherein:
the shackle-bar-slot is running-track-shaped;
in that the top and bottom end-walls of the slot are semi-circular, and are connected by straight side-walls.

10. As in claim 1, wherein:
the said shackle-bolt is termed the upper shackle-bolt;
the assembly includes a lower shackle-bolt, through which the load is transmitted, and which engages a through-hole in the shackle-bar; and
the portion of the shackle-bar between the through-hole and the shackle-bar-slot, under load, is stressed in tension.
